(19) United States
(12) Patent Application Publication
(10) Pub. No.: US 2011/0161242 A1
(43) Pub. Date: Jun. 30, 2011

(54) SYSTEMS AND METHODS FOR SEARCHING AND BROWSING MEDIA IN AN INTERACTIVE MEDIA GUIDANCE APPLICATION

(75) Inventors: David D. Chung, Santa Clara, CA (US); Walter R. Klappert, Los Angeles, CA (US)

(73) Assignee: Rovi Technologies Corporation, Santa Clara, CA (US)

(21) Appl. No.: 12/647,813

(22) Filed: Dec. 28, 2009

(51) Int. Cl. G06Q 99/00; G06Q 50/00; G06F 3/048

(52) U.S. Cl. 705/347; 715/810

(57) ABSTRACT

Systems and methods are discussed for providing guidance for media, particularly online video, by searching or browsing for media content based on user selections and user information. Browsing results are diversified using one or more techniques to provide a range of interesting results.

### BACKGROUND OF THE INVENTION

This invention relates generally to media guidance applications, and in particular, to providing guidance for video and other media obtained from the Internet.

The Internet has become an increasingly common resource for obtaining entertainment media. There are a vast number of media sources available via the Internet each of which provides access to many media assets.

The abundance of online media and media providers, however, has led to increasing difficulty for users to identify media of interest, particularly when the user does not have a specific media asset in mind. To locate online media content without guidance, a user would need to know a significant amount of information about the media. For example, if a user wants to find media related to a particular episode of a television show, or a particular movie, the user may need to directly access the media provider, e.g., a television network's or movie producer's website. Then, the user may need to know the original air date of the episode or the title of the episode in order to effectively locate media on the network website, or the movie title or other information about the movie. Not only is this process unwieldy for a user, the user must know exactly what to look for. Thus, guidance for Internet-delivered media content is necessary to enable or aid a user to easily and effectively locate media of interest that may be unknown to the user.

Some forms of guidance for media content provided on the Internet are already available. Many guidance applications for online media are limited to keyword searching and providing listings of featured and popular media. Neither of these types of applications, however, provides effective or systematic means for narrowing down the extremely large amount of media that is available on the Internet, especially when a user is simply browsing for media without any particular media in mind.

### SUMMARY OF THE INVENTION

Accordingly, systems and methods are provided for identifying and obtaining information for a set of media provided on the Internet, and displaying a subset of the identified media in a list. Systems and methods are also provided for browsing online media to provide diverse results based on a user's interests and viewing history.

In accordance with one embodiment of the invention, a method and system are presented for providing guidance for media on the Internet. A user selection may be received. User information indicating a user's media interactions may be retrieved from storage. A search for media assets may be performed using the user selection. The results may be narrowed to a subset of media assets allocating results based on identified categories of interest in the user information. In order to provide diversity in the result set for a browsing viewer, the result set may be diversified by adding an unrelated media asset to the subset of media assets. A display of the subset of media assets may be generated. Images used in the display of media asset results may be selected based on search queries, user information, or other basis.

User selections may be entered keywords, selections of a search or browse button, selection of a media asset icon or other selection. Selection of a media asset icon may cause retrieval of a keyword in a media asset profile for the media asset which can be used as a basis for a search. User selections and interactions may be stored as user information.

Media asset search results may be narrowed by allocating a certain number of results based on categories of interest to the user. The categories of interest may be identified by analyzing user information, in particular, duration of a user media interaction and user defined categories.

Diversity in the media asset result set may defined by a user. For example, the user may seek highly diverse results, only narrowly focused non-diverse results, or something between the two extremes. Diversity may be achieved by adding unrelated or contrary media assets to the result set. Such unrelated media assets may be identified: randomly, as being unrelated or contrary to the user selection or user information, or based on a keyword that is an antonym to the user selection. An unrelated media asset is one that includes attributes that are different than the attributes of media assets in a result set.

User information may be provided by a user profile which may include user defined preferences and information relating to monitored user media interactions. Media interactions may be used to identify categories of interest and assign relative importance, for example based on duration of the user interaction, to the categories of interest for allocating slots in a results subset. User media interactions may be continuously stored and used to update categories of interest and slot allocation to provide updated result sets.

In another embodiment, methods and systems for providing guidance of media on the Internet may include receiving a user selection for searching or browsing media content. The user selection may be used for performing a search and browse of media content to obtain search results and browse results, which differ. The search or browse results may be displayed when a search or browse are selected, respectively.

### BRIEF DESCRIPTION OF THE FIGURES

The above and other objects and advantages of the invention will be apparent upon consideration of the following detailed description, taken in conjunction with the accompanying drawings, in which like reference characters refer to like parts throughout, and in which:

FIGS. 1-3B show illustrative display screens that may be used to provide guidance for online video and other types of media;

FIG. 4 shows an illustrative user equipment device in accordance with an embodiment of the invention;

FIGS. 5-7 show illustrative systems in accordance with an embodiment of the invention;

FIGS. 8-9 show illustrative flow diagrams for browsing for media in accordance with embodiments of the invention;

FIG. 10 depicts an illustrative data structure for a user profile; and

FIG. 11 depicts an illustrative data structure for a media asset.

### DETAILED DESCRIPTION

The amount of media available to users in any given media delivery system can be substantial. Consequently, many users desire a form of media guidance through an interface that allows users to efficiently navigate media selections and easily identify media that they may desire. An application which provides such guidance is referred to herein as an interactive media guidance application or, sometimes, a media guidance application or a guidance application. Although some embodiments discussed herein are described in the context of online or internet based media guidance for online or internet based video, the principles may be applied to non-internet based media guidance, such as an interactive television program guide, as well as media distributed through non-internet based outlets, and combinations thereof.

For example, one typical type of media guidance application that provides guidance for online media is an interactive television program guide. Interactive television program guides (sometimes referred to as electronic program guides) are well-known guidance applications that, among other things, allow users to navigate among and locate many types of media content. Another example of a typical guidance application is a typical online search interface that may be used in a website to identify media content. Other than online media, such content may include conventional television programming (provided via traditional broadcast, cable, satellite, or other means), as well as pay-per-view programs, on-demand programs (as in video-on-demand (VOD) systems), media created by individuals, and other types of media or video content. Guidance applications may also allow users to navigate among and locate content related to the video content including, for example, video clips, articles, advertisements, chat sessions, games, etc.

With the advent of the Internet, mobile computing, and high-speed wireless networks, users are accessing media on personal computers (PCs) and other devices on which they traditionally did not, such as hand-held computers, personal digital assistants (PDAs), mobile telephones, or other mobile devices. On these devices users are able to navigate among and locate the same media available through a television. Consequently, media guidance is necessary on these devices, as well. The guidance provided may be for media content available only through a television, for media content available only through one or more of these devices, or for media content available both through a television and one or more of these devices. The media guidance applications may be provided as on-line applications (i.e., provided on a web-site), or as stand-alone applications or clients on hand-held computers, PDAs, mobile telephones, or other mobile devices. The various devices and platforms that may implement media guidance applications are described in more detail below.

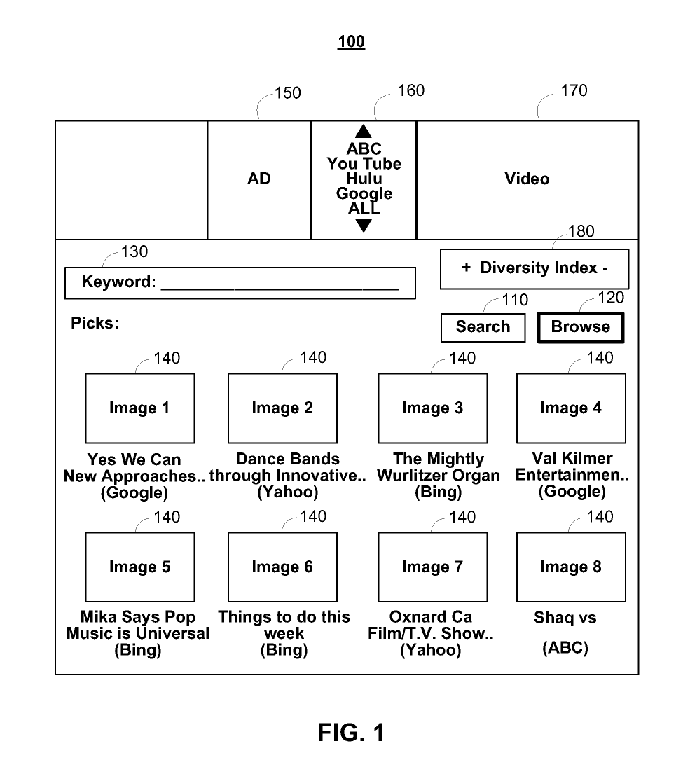

One of the functions of the media guidance application is to provide media listings and media information to users. FIGS. 1-3B show illustrative display screens that may be used to provide media guidance using a search and browse interface. The screens depicted in FIGS. 1-3B are meant to be simplified to highlight search and browse features. Of course other features and functionality may be included in the guidance interface. The display screens shown in FIGS. 1-3B may be implemented on any suitable device or platform. While the displays of FIGS. 1-3B are illustrated as full screen displays, they may also be fully or partially overlaid over media content being displayed.

Generally speaking an exemplary guidance interface screen 100 may include a search 110 and browse 120 button which may be selected to launch a search or browse for media assets. Searches and browses may be performed using keywords or other search criteria may be input, for example in keyword block 130. Searches and browses may also be performed without keywords by use of user information, if available, and other techniques further described herein. While the terms search and browse are often used interchangeably in the context of media guidance, each term is meant to have a different meaning herein. Searching for media assets may be performed with specific content in mind. For example, in a search for a particular movie, a user may use keywords for that movie, such as the title, actor, director, etc. On the other hand, browsing for media assets may be performed without any specific content in mind. This difference is akin to browsing in a store or window shopping for an unknown attractive item as compared to going to a store with a specific shopping list. When providing browsing results, content selection methods may take into account past viewer inputs in order to provide diverse results. User history or other user information may also be used to identify media content in a browsing context.

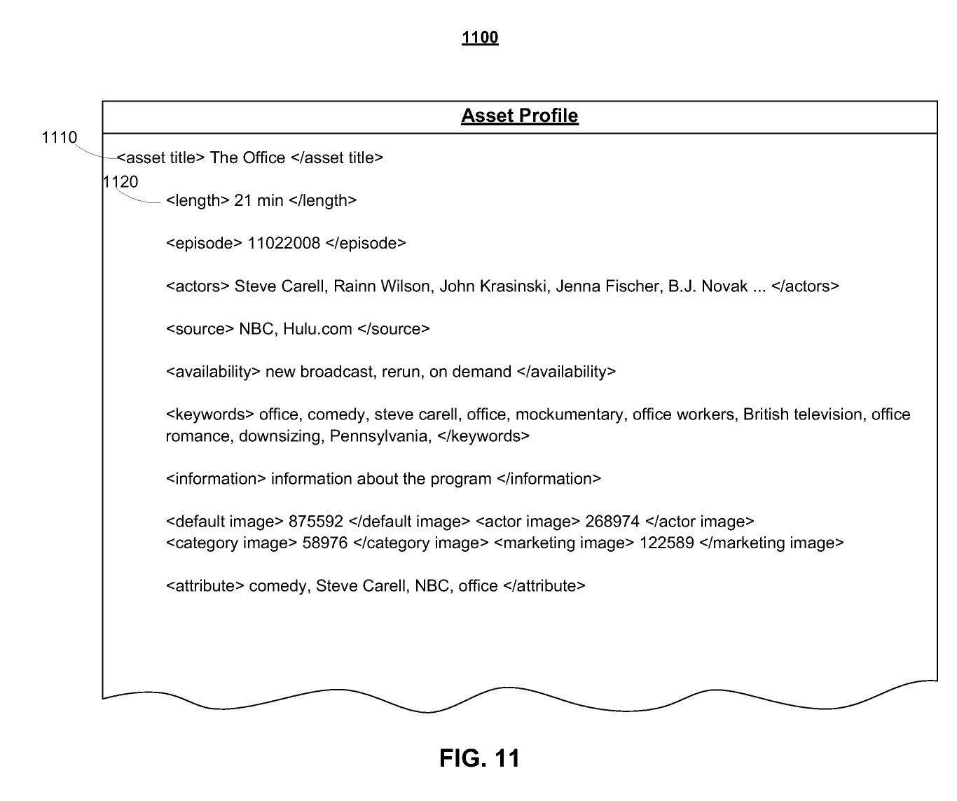

Turning now to FIG. 1, a browse and search interface display may include certain media content may be displayed for a user without any keywords entered. Such content may be displayed in the screen as media asset icons 140. Media asset icons 140 may be graphical representations of associated media assets, which can include any type of media asset, such as video, photographs, audio, pictures, websites, etc. The graphical representation of icon 140 may be a representative image from the media asset. Multiple image files may be associated with media assets, (see for example the asset profile shown in FIG. 11.) For example, a media asset may have a marketing image that may be selected to stand out among other images, or that is visually appeal, etc. The media asset may also have actor images that may be used, for example, when a search query includes an actor name. Similarly, a category image that is selected to be representative of the media asset within a particular category or genre may be used when a category or genre is used in a search query, in the user preferences or user information. The icons 140 may be selected to access the associated media asset, information about the media asset and other options associated with the media asset, such as recording, alarm clock reminders, or other options. Information about any user selections of icons 140 may be stored, as described further herein. The media asset icons 140 may indicate media assets relevant to a search or browse that is based on user information, and/or any entered user selections. Alternatively, the media asset icons 140 may be listed as initial suggestions that are presented in display screen 100. Other screen elements in the display may include, for example, advertisement 150, channel or source selection list 160, video display 170, diversity index 180 or other elements.

Advertisement 150 may provide an advertisement for media content that, (depending on a viewer's access rights, e.g., for subscription programming) is currently available for viewing, will be available for viewing in the future, or may never become available for viewing, and may correspond to or be unrelated to one or more of the media asset icons 140. Advertisement 150 may also be for products or services related or unrelated to the media asset icons 140. Advertisement 150 may be selectable and provide further information about media content, provide information about a product or a service, enable purchasing of media content, a product, or a service, provide media content relating to the advertisement, etc. Advertisement 150 may be targeted based on a user's profile/preferences, monitored user activity, the type of display provided, or on other suitable targeted advertisement bases.

While advertisement 150 is shown as rectangular or banner shaped, advertisements may be provided in any suitable size, shape, and location in a guidance application display. In addition, advertisements may be overlaid over media content or a guidance application display or embedded within a display. Advertisements may also include text, images, rotating images, video clips, or other types of media content. Advertisements may be stored in the user equipment with the guidance application, in a database connected to the user equipment, in a remote location (including streaming media servers), or on other storage means or a combination of these locations. Providing advertisements in a media guidance application is discussed in greater detail in, for example, Knudson et al., U.S. patent application Ser. No. 10/347,673, filed Jan. 17, 2003, Ward, III et al. U.S. Pat. No. 6,756,997, issued Jun. 29, 2004, and Schein et al. U.S. Pat. No. 6,388,714, issued May 14, 2002, which are hereby incorporated by reference herein in their entireties. It will be appreciated that advertisements may be included in other media guidance application display screens of the present invention.

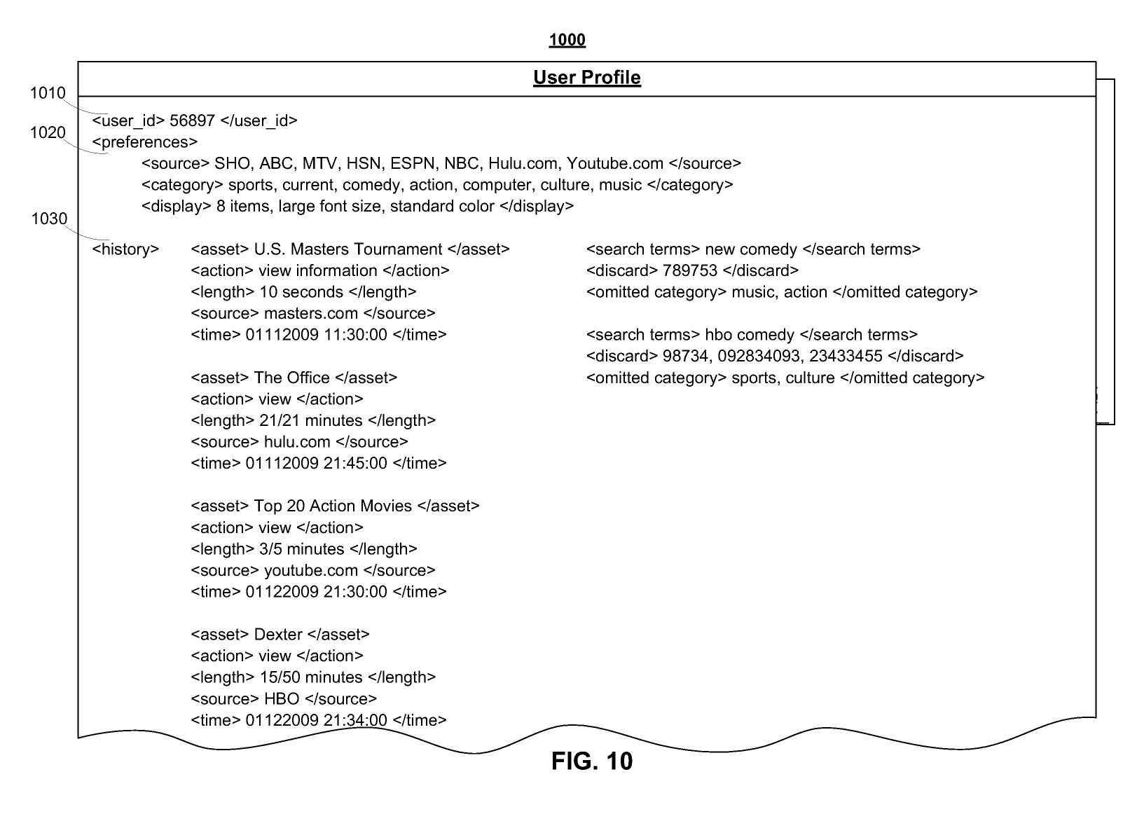

Also included in display 100 is a channel or source selection list 160. The channel list 160 may be a list of sources of media assets, such as television channels (ABC, On Demand channels, HBO, and other channels) or video websites, for example, Hulu.com, YouTube.com, or other sources, iTunes, etc. The channel list 160 may be used to indicate that all listed sources are being used in a search. A user may also select sources from channel list 160 for source limited searches. Channel and source list 160 may be listed in an order according to user history or user preferences, displayed alphabetically or based on some other order. Channel sources may be selected in a search or browse and any such selections may be used as a basis for providing search or browse results as well as captured as user history to be used in following searches and browses. For example, a user may have a user profile, such as the profile 1000 shown in the illustrative profile data file of FIG. 10. The user profile 1000 typically includes a user identifier 1010, and user information, including preferences 1020, and history 1030. As shown in the examples in FIG. 10, a user may have certain preferences 1020, such as media sources or categories of media. Other preferences may also be used. User preferences 1020 may be obtained via direct user selections, for example, using the interactive guide, or may be based on analysis of user behavior and viewing history. For example, if a user only views media assets associated with a particular source, that source may be included as a preferred source. In another example, if a user only views sports media, sports may be included as a preferred category of media.

Video 170 may be used to allow the user to view and/or preview programs that are currently available, will be available, or were available to the user. The content of video region 170 may correspond to, or be independent from, one of the listed media asset icons 140.

A diversity index 180 may be a selectable element of display screen 100 that provides the user with the ability to tailor relatedness of search or browse results, for example, to be highly diverse, narrowly focused, or somewhere in the middle. If the diversity index 180 is set to be low, the search or browse results will be narrowly focused to be related to the search query. If the diversity index 180 is set at a higher level, the browse or search results may be very diverse and may be less closely related to the search query. Accordingly, browse and search results provided for one search query may differ based on the diversity setting. The diversity index 180 may be a slidable button, plus/minus buttons, or other suitable interface. The diversity index 180 may be used with either searches or browses.

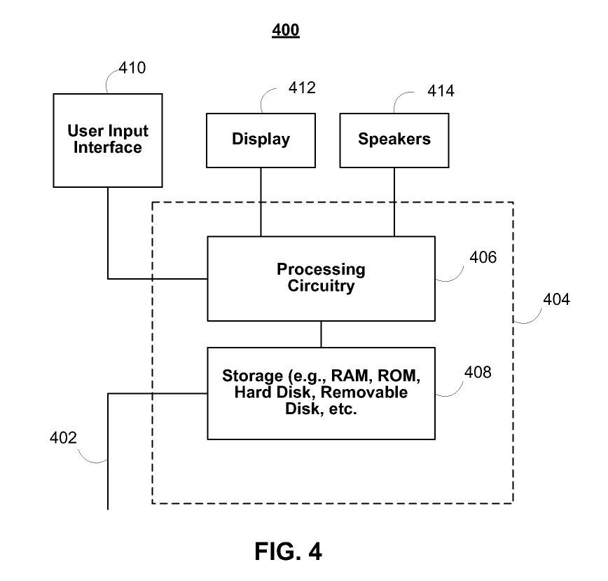

An initial display screen may be configured to display certain media assets of interest, e.g., media content 140 of FIG. 1. Such media may be identified as general items of interest, or based on one or more parameters, including a user's history or preferences, community ratings, popularity, age of the media, access and availability, or other parameters. These parameters may be accessed from user profile 1000 using processing circuitry, further described herein. Ideally the media assets selected to be displayed in an initial screen may be chosen to provide a wide range of a media that may be of interest to a particular viewer or to a general audience (if no information is available about the user). Diversity of the results may be important in a browsing context so that obscure or random content is included in the results along with content identified using matching techniques. This diversity presents a user with media content that they may not have seen before. A diverse pool of identified media assets may be obtained using information about a particular viewer, including user history, user history and profiles, as well as more general information, further described herein. Some examples of user history may include past viewing history, specifically media viewed and duration of the viewing, search or browse history, including keywords entered, selected results, and icon selections. Such user information may be stored in network storage, further described in reference to FIGS. 4-7, in a data profile such as profile 1000.

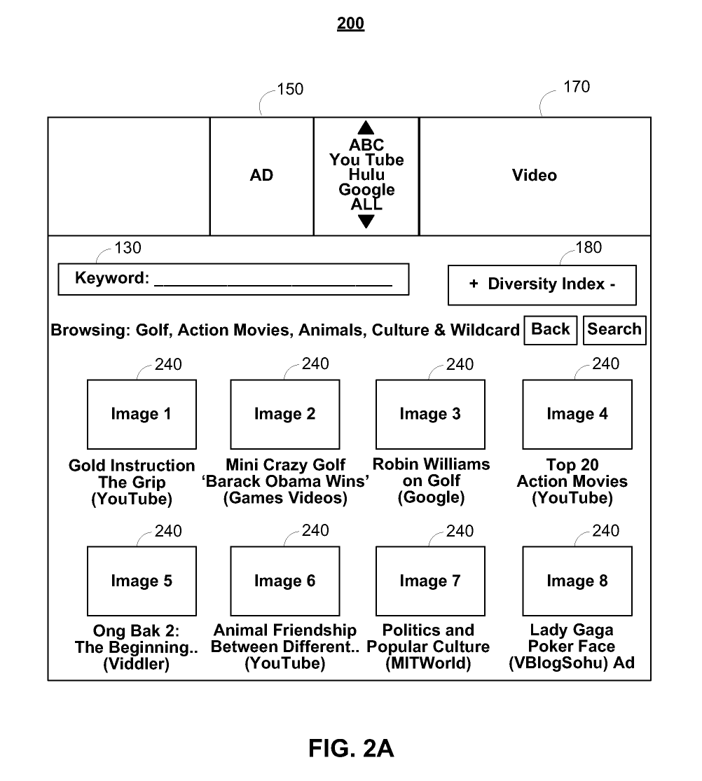

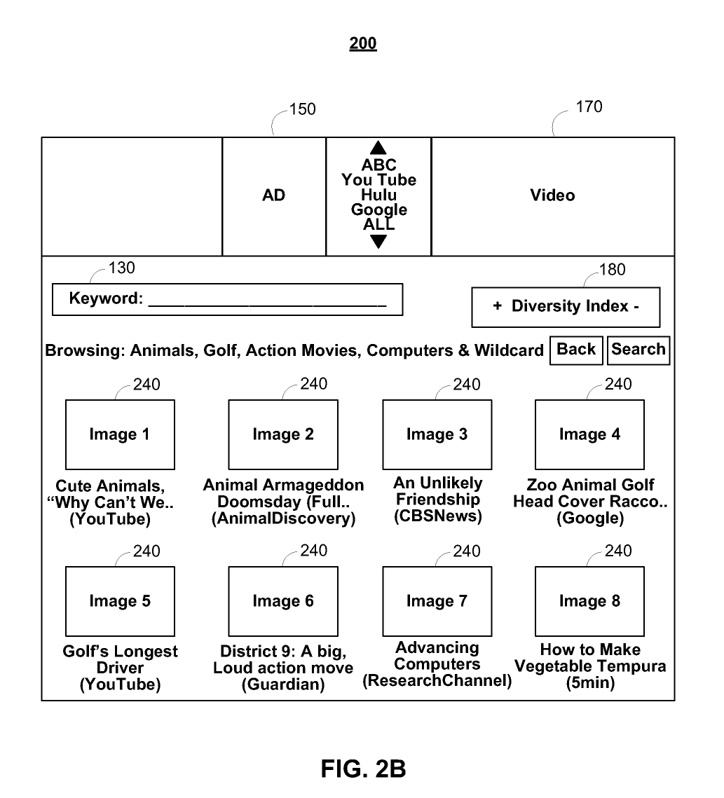

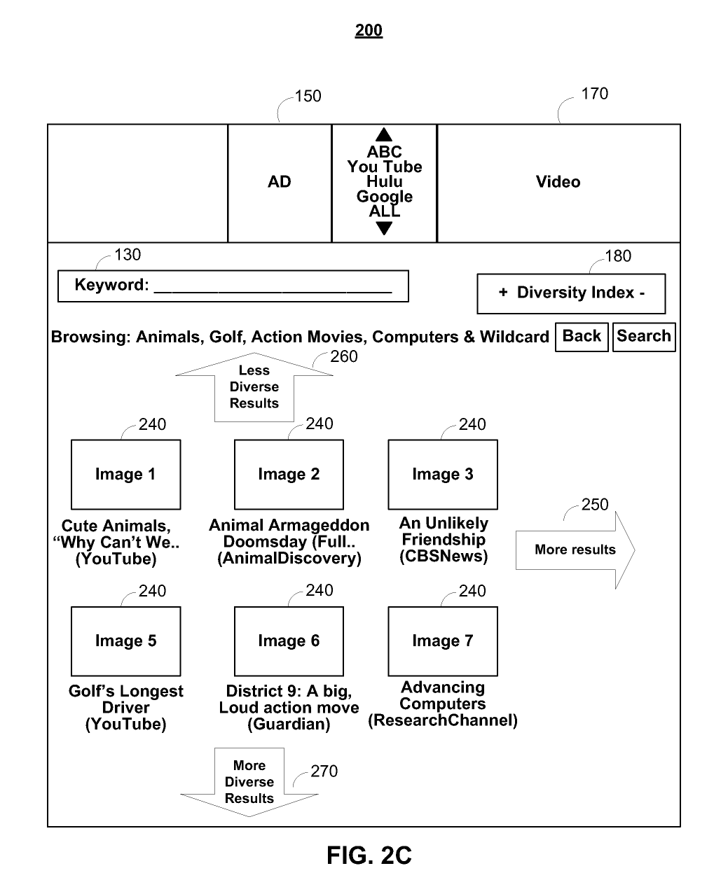

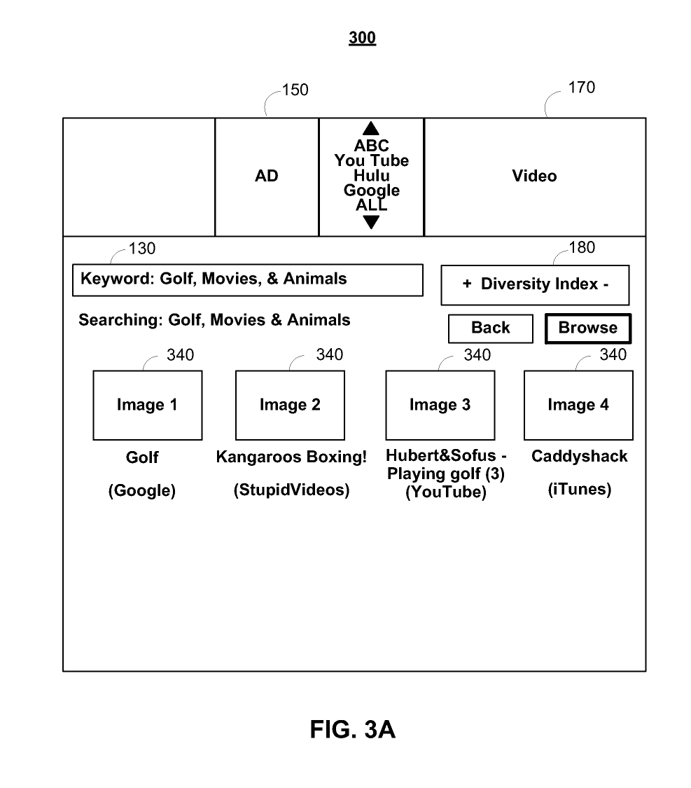

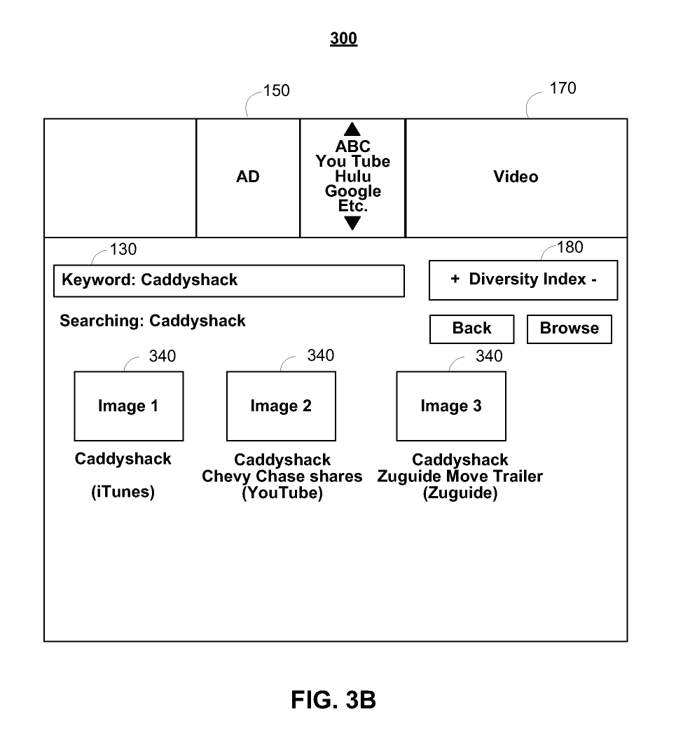

As mentioned above, user information may be used to shape display screens directed to a user, such as those shown in FIGS. 2A-3B. As shown in FIG. 2A certain user history may be obtained that indicates user interest in golf, action movies, animals, and culture. In an embodiment, an unrelated media asset may also be added to provide diverse and interesting results. Generally speaking, user history may be obtained from network storage and may be based on prior keywords or prior search history, viewership patterns, including duration of viewing, time elapsed since viewed, and categories of items viewed, and combinations thereof. FIG. 2B presents media asset 240 results which differ from those depicted in FIG. 2A and are based on user history of animals, golf, action movies, computer and a wildcard, or unrelated media asset. FIG. 2C presents another view of media asset results. As shown in FIG. 2C, additional media asset results may be obtained by selecting one of the arrows 250, 260 or 270. The results provided when arrow 250 is selected may be additional results having the same diversity and parameters used to provide the media asset 240 results in display 200. Additional results provided when arrow 260 is selected may be less diverse, e.g., more focused, than the original media asset 240 results in display 200. When arrow 270 is selected, additional results may be provided that are more diverse, e.g., broader and less related to the search query, than the media asset 240 results provided in display 200. The results shown in FIGS. 1-2C may be obtained by entering certain keywords in block 130, based solely on user information, or a combination thereof.

In addition to the browse functionality, a search feature may also be provided in the guidance application. An exemplary search interface is depicted in FIGS. 3A-3B. As shown, keywords may be entered in block 130 to identify results 340. The media asset results 340 may be identified using conventional search algorithms that may, for example, match keywords with metadata associated with the media content. As shown in FIGS. 3A-3B, media content search results will ideally omit duplicates and also present information about the media asset 340, including at least the title and source.

A media guidance application, such as an application that provides display screen 100-300 of FIGS. 1-3B, may be personalized based on a user's preferences, which may be stored in a user profile 1000. A personalized media guidance application allows a user to customize displays and features to create a personalized “experience” with the media guidance application. This personalized experience may be created by allowing a user to input these customizations and/or by the media guidance application monitoring user activity to determine various user preferences. Users may access their personalized guidance application by logging in or otherwise identifying themselves to the guidance application. Customization of the media guidance application may be made in accordance with a user profile 1000. The customizations may include varying presentation schemes (e.g., color scheme of displays, font size of text, etc.), aspects of media content listings displayed (e.g., recommended media content, etc.), aspects of criteria elements displayed (e.g., ordering of categories or criteria elements, etc.), parental control settings, and other desired customizations.

The media guidance application may allow a user to provide user profile information or may automatically compile user profile information based on user interactions. The media guidance application may, for example, monitor any media the user accesses and/or other interactions the user may have with the guidance application. Analysis of the user interactions by processing circuitry, either locally implemented on user equipment, or at a remote facility, may be performed to identify trends for the user profile. Additionally, the media guidance application may obtain all or part of other user profiles that are related to a particular user (e.g., from other web sites on the Internet the user accesses, such as www.tvguide.com, from other media guidance applications the user accesses, from other interactive applications the user accesses, from a handheld device of the user, etc.), and/or obtain information about the user from other sources that the media guidance application may access. As a result, a user can be provided with a unified guidance application experience across the user's different devices. Additional personalized media guidance application features are described in greater detail in Ellis et al., U.S. patent application Ser. No. 11/179,410, filed Jul. 11, 2005, Boyer et al., U.S. patent application Ser. No. 09/437,304, filed Nov. 9, 1999, and Ellis et al., U.S. patent application Ser. No. 10/105,128, filed Feb. 21, 2002, which are hereby incorporated by reference herein in their entireties.

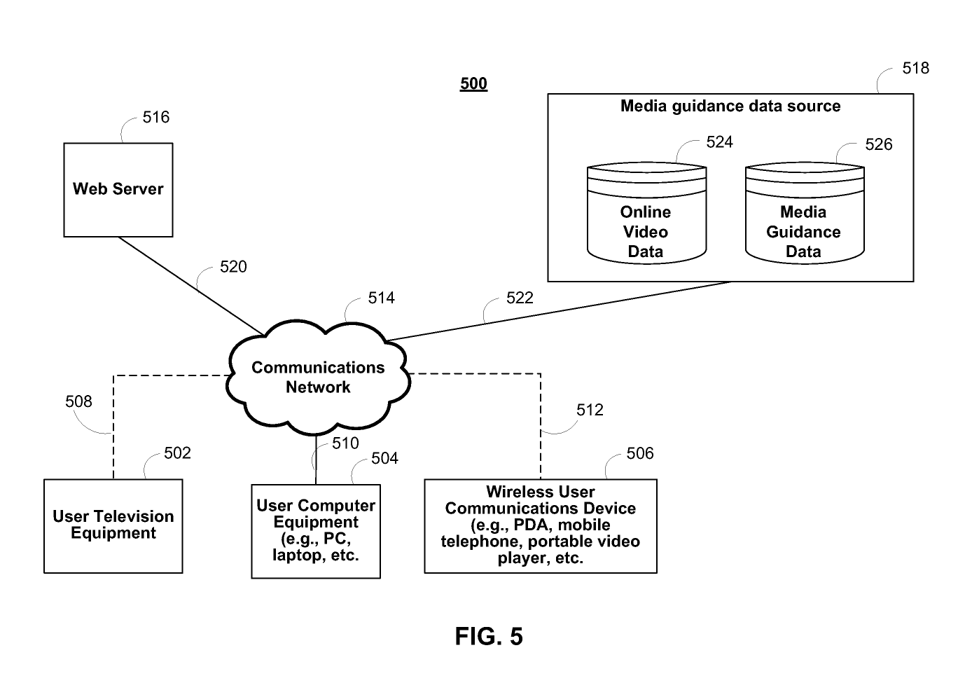

Media search and browse embodiments may be implemented using the components and architecture depicted in FIGS. 4-7. Users may access media content and the media guidance application (and its display screens described above) from one or more of their user equipment devices. FIG. 4 shows a generalized embodiment of illustrative user equipment device 400. More specific implementations of user equipment devices are discussed below in connection with FIG. 5. User equipment device 400 may receive media content and data via input/output (hereinafter “I/O”) path 402. I/O path 402 may provide media content (e.g., video, on-demand programming, Internet content, and other video or audio, or other media) and data to control circuitry 404, which includes processing circuitry 406 and storage 408. Control circuitry 404 may be used to send and receive commands, requests, and other suitable data using I/O path 402. I/O path 402 may connect control circuitry 404 (and specifically processing circuitry 406) to one or more communications paths (described below). I/O functions may be provided by one or more of these communications paths, but are shown as a single path in FIG. 4 to avoid overcomplicating the drawing.

Control circuitry 404 may be based on any suitable processing circuitry 406 such as processing circuitry based on one or more microprocessors, microcontrollers, digital signal processors, programmable logic devices, etc. In some embodiments, control circuitry 404 executes instructions for a media guidance application stored in memory (i.e., storage 408). In client-server based embodiments, control circuitry 404 may include communications circuitry suitable for communicating with a guidance application server or other networks or servers. Communications circuitry may include a cable modem, an integrated services digital network (ISDN) modem, a digital subscriber line (DSL) modem, a telephone modem, or a wireless modem for communications with other equipment. Such communications involve the Internet for at least obtaining online media content and additionally may involve any other suitable communications networks or paths (which is described in more detail in connection with FIG. 5). In addition, communications circuitry may include circuitry that enables peer-to-peer communication of user equipment devices, or communication of user equipment devices in locations remote from each other (described in more detail below).

Memory (e.g., random-access memory, read-only memory, or any other suitable memory), hard drives, optical drives, or any other suitable fixed or removable storage devices (e.g., DVD recorder, CD recorder, video cassette recorder, or other suitable recording device) may be provided as storage 408 that is part of control circuitry 404. Storage 408 may include one or more of the above types of storage devices. For example, user equipment device 400 may include a hard drive for a DVR (sometimes called a personal video recorder, or PVR) and a DVD recorder as a secondary storage device. Storage 408 may be used to store various types of media described herein and guidance application data, including program information, guidance application settings, user preferences or profile information, or other data used in operating the guidance application. Nonvolatile memory may also be used (e.g., to launch a boot-up routine and other instructions).

Control circuitry 404 may include video generating circuitry and tuning circuitry, such as one or more analog tuners, one or more MPEG-2 decoders or other digital decoding circuitry, high-definition tuners, or any other suitable tuning or video circuits or combinations of such circuits. Encoding circuitry (e.g., for converting over-the-air, analog, or digital signals to MPEG signals for storage) may also be provided. Control circuitry 404 may also include scaler circuitry for upconverting and downconverting media into the preferred output format of the user equipment 400. Circuitry 404 may also include digital-to-analog converter circuitry and analog-to-digital converter circuitry for converting between digital and analog signals. The tuning and encoding circuitry may be used by the user equipment to receive and to display, to play, or to record media content. The tuning and encoding circuitry may also be used to receive guidance data. The circuitry described herein, including for example, the tuning, video generating, encoding, decoding, scaler, and analog/digital circuitry, may be implemented using software running on one or more general purpose or specialized processors. Multiple tuners may be provided to handle simultaneous tuning functions (e.g., watch and record functions, picture-in-picture (PIP) functions, multiple-tuner recording, etc.). If storage 408 is provided as a separate device from user equipment 400, the tuning and encoding circuitry (including multiple tuners) may be associated with storage 408.

A user may control the control circuitry 404 using user input interface 410. User input interface 410 may be any suitable user interface, such as a remote control, mouse, trackball, keypad, keyboard, touch screen, touch pad, stylus input, joystick, voice recognition interface, or other user input interfaces. Display 412 may be provided as a stand-alone device or integrated with other elements of user equipment device 400. Display 412 may be one or more of a monitor, a television, a liquid crystal display (LCD) for a mobile device, or any other suitable equipment for displaying visual images. In some embodiments, display 412 may be HDTV-capable. Speakers 414 may be provided as integrated with other elements of user equipment device 400 or may be stand-alone units. The audio component of videos and other media content displayed on display 412 may be played through speakers 414. In some embodiments, the audio may be distributed to a receiver (not shown), which processes and outputs the audio via speakers 414.

User equipment device 400 of FIG. 4 can be implemented in system 500 of FIG. 5 as user television equipment 502, user computer equipment 504, wireless user communications device 506, or any other type of user equipment suitable for accessing media, such as a non-portable gaming machine. For simplicity, these devices may be referred to herein collectively as user equipment or user equipment devices. User equipment devices, on which a media guidance application is implemented, may function as a standalone device or may be part of a network of devices. Various network configurations of devices may be implemented and are discussed in more detail below.

User television equipment 502 may include a set-top box, an integrated receiver decoder (IRD) for handling satellite television, a television set, a digital storage device, a DVD recorder, a video-cassette recorder (VCR), a local media server, or other user television equipment. One or more of these devices may be integrated to be a single device, if desired. User computer equipment 504 may include a PC, a laptop, a tablet, a WebTV box, a personal computer television (PC/TV), a PC media server, a PC media center, or other user computer equipment. WEBTV is a trademark owned by Microsoft Corp. Wireless user communications device 506 may include PDAs, a mobile telephone, a portable video player, a portable music player, a portable gaming machine, or other wireless devices.

It should be noted that with the advent of television tuner cards for PC's, WebTV, and the integration of video into other user equipment devices, the lines have become blurred when trying to classify a device as one of the above devices. In fact, each of user television equipment 502, user computer equipment 504, and wireless user communications device 506 may utilize at least some of the system features described above in connection with FIG. 4 and, as a result, include flexibility with respect to the type of media content available on the device. For example, user television equipment 502 may be Internet-enabled allowing for access to Internet content, while user computer equipment 504 may include a tuner allowing for access to television programming. The media guidance application may also have the same layout on the various different types of user equipment or may be tailored to the display capabilities of the user equipment. For example, on user computer equipment, the guidance application may be provided as a web site accessed by a web browser. In another example, the guidance application may be scaled down for wireless user communications devices.

In system 500, there is typically more than one of each type of user equipment device but only one of each is shown in FIG. 5 to avoid overcomplicating the drawing. In addition, each user may utilize more than one type of user equipment device (e.g., a user may have a television set and a computer) and also more than one of each type of user equipment device (e.g., a user may have a PDA and a mobile telephone and/or multiple television sets).

The user may also set various settings to maintain consistent media guidance application settings across in-home devices and remote devices. Settings include those described herein, as well as channel and program favorites, programming preferences that the guidance application utilizes to make programming recommendations, display preferences, and other desirable guidance settings. For example, if a user sets a channel as a favorite on, for example, the web site www.tvguide.com on their personal computer at their office, the same channel would appear as a favorite on the user's in-home devices (e.g., user television equipment and user computer equipment) as well as the user's mobile devices, if desired. Therefore, changes made on one user equipment device can change the guidance experience on another user equipment device, regardless of whether they are the same or a different type of user equipment device. In addition, the changes made may be based on settings input by a user, as well as user activity monitored by the guidance application.

The user equipment devices may be coupled to communications network 514. Namely, user television equipment 502, user computer equipment 504, and wireless user communications device 506 are coupled to communications network 514 via communications paths 508, 510, and 512, respectively. Communications network 514 include the Internet and additionally may be one or more other networks including, a mobile phone network, mobile device (e.g., Blackberry) network, cable network, public switched telephone network, or other types of communications network or combinations of communications networks. BLACKBERRY is a trademark owned by Research In Motion Limited Corp. Paths 508, 510, and 512 may separately or together include one or more communications paths, such as, a satellite path, a fiber-optic path, a cable path, a path that supports Internet communications (e.g., IPTV), free-space connections (e.g., for broadcast or other wireless signals), or any other suitable wired or wireless communications path or combination of such paths. Path 512 is drawn with dotted lines to indicate that in the exemplary embodiment shown in FIG. 5 it is a wireless path and paths 508 and 510 are drawn as solid lines to indicate they are wired paths (although these paths may be wireless paths, if desired). Communications with the user equipment devices may be provided by one or more of these communications paths, but are shown as a single path in FIG. 5 to avoid overcomplicating the drawing.

Although communications paths are not drawn between user equipment devices, these devices may communicate directly with each other via communication paths, such as those described above in connection with paths 508, 510, and 512, as well other short-range point-to-point communication paths, such as USB cables, I6E 1394 cables, wireless paths (e.g., Bluetooth, infrared, I6E 802-11×, etc.), or other short-range communication via wired or wireless paths. BLUETOOTH is a trademark owned by Bluetooth SIG, INC. The user equipment devices may also communicate with each other directly through an indirect path via communications network 514.

System 500 includes web server 516 and media guidance data source 518 coupled to communications network 514 via communication paths 520 and 522, respectively. Paths 520 and 522 may include any of the communication paths described above in connection with paths 508, 510, and 512. Communications with the web server 516 and media guidance data source 518 may be exchanged over one or more communications paths, but are shown as a single path in FIG. 5 to avoid overcomplicating the drawing. In addition, there may be more than one of each of web server 516 and media guidance data source 518, but only one of each is shown in FIG. 5 to avoid overcomplicating the drawing. (The different types of each of these sources are discussed below.) If desired, web server 516 and media guidance data source 518 may be integrated as one source device. Although communications between sources 516 and 518 with user equipment devices 502, 504, and 506 are shown as through communications network 514, in some embodiments, sources 516 and 518 may communicate directly with user equipment devices 502, 504, and 506 via communication paths (not shown) such as those described above in connection with paths 508, 510, and 512.

Online media may be provided by web server 516. Web server 516 may provide a website of an online media provider (e.g., television network website, entertainment website, movie website, or a website that aggregates content from multiple sources). Although only one web server 516 is shown in FIG. 5, many servers may be used. The online media provider may host a variety of content (e.g., full-length movies/television episodes, segments of movies/episodes, trailers/previews, interviews with actors/directors/producers, music videos, original online-only content, promotions for a network or program, etc.). The online media provider may host media of various types (e.g. streaming, downloadable, user generated, professionally generated, etc.). The provided online media may be stored locally at web server 516 or in a remote media server. In addition to the media content, web server 516 may store metadata (e.g., title, description, URL, etc.) for each provided media.

One or more of other media sources (not shown) may also provide media content to user equipment, and be connected to the communications network by one or more paths that may include any of the communication paths described above in connection with paths 508, 510, and 512. Other media sources may include one or more types of media distribution equipment including a television distribution facility, cable system headend, satellite distribution facility, programming sources (e.g., television broadcasters, such as NBC, ABC, HBO, etc.), intermediate distribution facilities and/or servers, on-demand media servers, and other media content providers. NBC is a trademark owned by the National Broadcasting Company, Inc., ABC is a trademark owned by the ABC, INC., and HBO is a trademark owned by the Home Box Office, Inc. Other media sources may be the originator of media content (e.g., a television broadcaster, a Webcast provider, etc.) or may not be the originator of media content (e.g., an on-demand media content provider, etc.). Other media sources may include cable sources, satellite providers, on-demand providers, or other providers of media content. Other media sources may also include a remote media server used to store different types of media content (including video content selected by a user), in a location remote from any of the user equipment devices. Systems and methods for remote storage of media content, and providing remotely stored media content to user equipment are discussed in greater detail in connection with Ellis et al., U.S. patent application Ser. No. 09/332,244, filed Jun. 11, 1999, which is hereby incorporated by reference herein in its entirety.

Media guidance data source 518 may provide media guidance data for a media guidance application. Media guidance data source 518 includes data store 524 and 526, and may provide guidance data from either data store. The guidance data may include program information such as a program title, an episode title, an episode synopsis, editorial commentary, etc., typically found in, for example, TV Guide Magazine or on www.tvguide.com. Data stores 524 and 526 may be one or more relational databases or other suitable storage mechanisms. Data stores 524 and 526 may be local (as shown in system 500) or in remote locations.

Data store 526 stores media guidance data that may or may not be available online. The stored media guidance data may include media listings, media-related information (e.g., broadcast times, broadcast channels, media titles, media descriptions, ratings information (e.g., parental control ratings, critic's ratings, etc.), genre or category information, actor information, logo data for broadcasters' or providers' logos, etc.), media format (e.g. MPEG), advertisement information (e.g. text, images, media clips, etc.), and any other type of guidance data that is helpful for a user to navigate among and locate desired media selections. Data store 526 may also store identifiers into data store 524 that reference related media.

Media guidance data source 518 may also include data store 524. Data store 524 stores information related to the videos available on web servers 516. Data store 524 may store the metadata (e.g., title, description, URL, etc.) associated with each video from web servers 516, or may store information derived from the metadata. Data store 524 may also store metadata not provided from web servers 516 (e.g., date entered into data store 524, popularity, user generated tags/keywords, etc.). Data store 524 may store identifiers into data store 526 to indicate additional media guidance data related to the videos found from web servers 516. In some embodiments, data store 524 stores the online media provided by web servers 516 along with information about the media.

Media guidance application data may be provided to the user equipment devices using any suitable approach. In some embodiments, the guidance application may be a stand-alone interactive television program guide that receives program guide data via a data feed (e.g., a continuous feed, trickle feed, or data in the vertical blanking interval of a channel). Program schedule data and other guidance data may be provided to the user equipment on a television channel sideband, in the vertical blanking interval of a television channel, using an in-band digital signal, using an out-of-band digital signal, or by any other suitable data transmission technique. Program schedule data and other guidance data may be provided to user equipment on multiple analog or digital television channels. Program schedule data and other guidance data may be provided to the user equipment with any suitable frequency (e.g., continuously, daily, a user-specified period of time, a system-specified period of time, in response to a request from user equipment, etc.). In some approaches, guidance data from media guidance data source 518 and/or other media sources may be provided to users' equipment using a client-server approach. For example, a guidance application client residing on the user's equipment may initiate sessions with source 518 to obtain guidance data when needed. Media guidance data source 518 may provide user equipment devices 502, 504, and 506 the media guidance application itself or software updates for the media guidance application.

Media guidance applications may be, for example, stand-alone applications implemented on user equipment devices. In other embodiments, media guidance applications may be client-server applications where only the client resides on the user equipment device. For example, media guidance applications may be implemented partially as a client application on control circuitry 411 of user equipment device 400 and partially on a remote server as a server application (e.g., media guidance data source 518). The guidance application displays may be generated by the media guidance data source 518 and transmitted to the user equipment devices. The media guidance data source 518 may also transmit data for storage on the user equipment, which then generates the guidance application displays based on instructions processed by control circuitry.

Media guidance system 500 is intended to illustrate a number of approaches, or network configurations, by which user equipment devices and sources of media content and guidance data may communicate with each other for the purpose of accessing media, including Internet-delivered content, and providing media guidance. The present invention may be applied in any one or a subset of these approaches, or in a system employing other approaches for delivering media and providing media guidance. The following three approaches provide specific illustrations of the generalized example of FIG. 5.

In one approach, user equipment devices may communicate with each other within a home network. User equipment devices can communicate with each other directly via short-range point-to-point communication schemes describe above, via indirect paths through a hub or other similar device provided on a home network, or via communications network 514. Each of the multiple individuals in a single home may operate different user equipment devices on the home network. As a result, it may be desirable for various media guidance information, including media guidance information for Internet-delivered content, or settings to be communicated between the different user equipment devices. For example, it may be desirable for users to maintain consistent media guidance application settings on different user equipment devices within a home network, as described in greater detail in Ellis et al., U.S. patent application Ser. No. 11/179,410, filed Jul. 11, 2005. Different types of user equipment devices in a home network may also communicate with each other to transmit media content. For example, a user may transmit online media content from user computer equipment to a portable video player or portable music player.

In a second approach, users may have multiple types of user equipment by which they access media content, including Internet-delivered media content, and obtain media guidance. For example, some users may have home networks that are accessed by in-home and mobile devices. Users may control in-home devices via a media guidance application implemented on a remote device. For example, users may access an online media guidance application on a website via a personal computer at their office, or a mobile device such as a PDA or web-enabled mobile telephone. The user may set various settings (e.g., recordings, reminders, or other settings) on the online guidance application to control the user's in-home equipment. The online guide may control the user's equipment directly, or by communicating with a media guidance application on the user's in-home equipment. Various systems and methods for user equipment devices communicating, where the user equipment devices are in locations remote from each other, is discussed in, for example, Ellis et al., U.S. patent application Ser. No. 10/927,814, filed Aug. 26, 2004, which is hereby incorporated by reference herein in its entirety.

In a third approach, users of user equipment devices inside and outside a home can use their media guidance application to communicate directly with web servers 516 or other media content sources to access Internet-delivered and other media content. Specifically, within a home, users of user television equipment 504 and user computer equipment 506 may access the media guidance application to navigate among and locate desirable media content. Users may also access the media guidance application outside of the home using wireless user communications devices 506 to navigate among and locate desirable media content.

It will be appreciated that while the discussion of media content has focused on video content, the principles of media guidance can be applied to other types of media content, such as music, images, writings, etc.

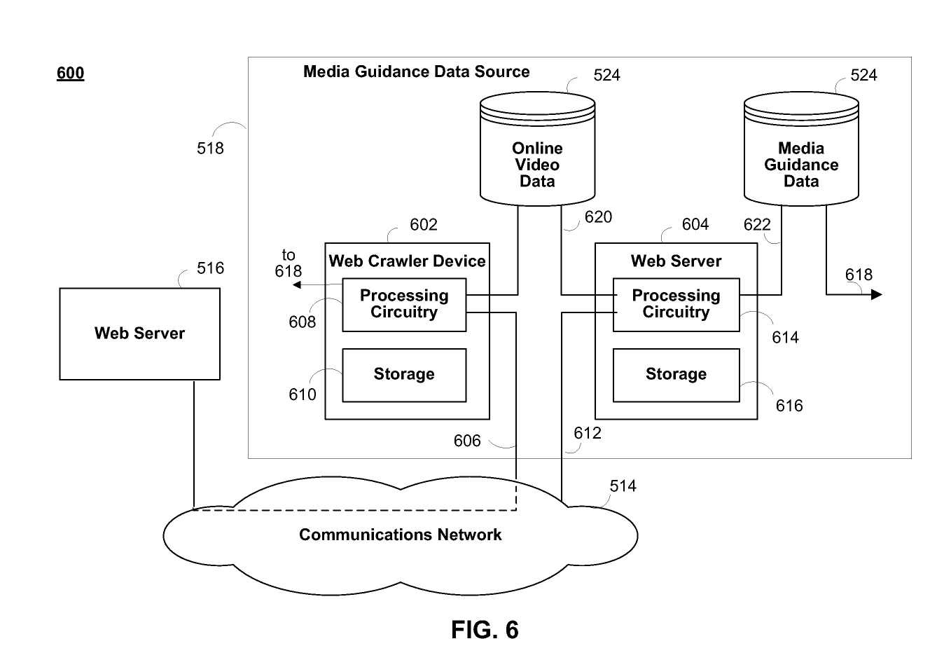

A more detailed view of an embodiment of media guidance data source 518 is shown in FIG. 6. In addition to data stores 524 and 526, media guidance data source 518 may contain web crawler device 602 and web server 604. Web crawler device 602 and web server 604 may each include one or more of processing circuitry 614 and 608, and storage 616 and 610. They may include any of the features and components of a user equipment device, described above in connection with FIG. 4. They may additionally include any circuitry or stored software (e.g., database drivers, web crawler device applications, web server applications, etc.). Web crawler device 602 and web server 604 interact with data stores 524 and 526 through I/O paths 610, 618, 620, and 622. Web crawler device 602 and web server 604 communicate with communications network 514 through I/O paths 606 and 612, which are referred to collectively as link 522 in FIG. 5. I/O paths 606, 610, 612, 618, 620, and 622 may be any suitable communication paths described above in connection with 508, 516, and 512. Although web crawler device 602 and web server 604 are shown as separate entities, their functions may be performed by a single unit.

In a typical scenario, web crawler device 602 obtains online media information (e.g., metadata) and, in some embodiments, online media content originally provided from web servers 1116. That is, web crawler device 602 captures information on online media available on the Internet. Such information may be stored in a media asset profile, further described herein. In FIG. 6, a dotted line is shown between link 606 and web server 516 to indicate that web crawler device 602 directly requests media and media information from web server 516. Web crawler device 602 may then store information on the available online media in data store 524. To do so, web crawler device 602 may access, retrieve, add, update, or remove data from data store 524. Web crawler device 602 may store information on web servers 1116 in storage 610. Thus, web crawler device 602 may store captured information directly in data store 524 or may first process the captured information using related data in data store 526 and/or storage 610.

In a typical scenario, web server 604 may access or retrieve data from data store 524 and 526. Web server 604 may use retrieved data from either or both data stores to provide media guidance application data for a media guidance application. Web server 604 may store user personalization data (e.g., user profiles 1000) in storage 616 and any other suitable information for preparing a display and/or data. Web server 604 may provide data through I/O link 612 using any of the approaches described above in connection with FIG. 5. For example, web server 604 may send raw data, processed data, or may prepare a display, depending on the type of user equipment and/or guidance application.

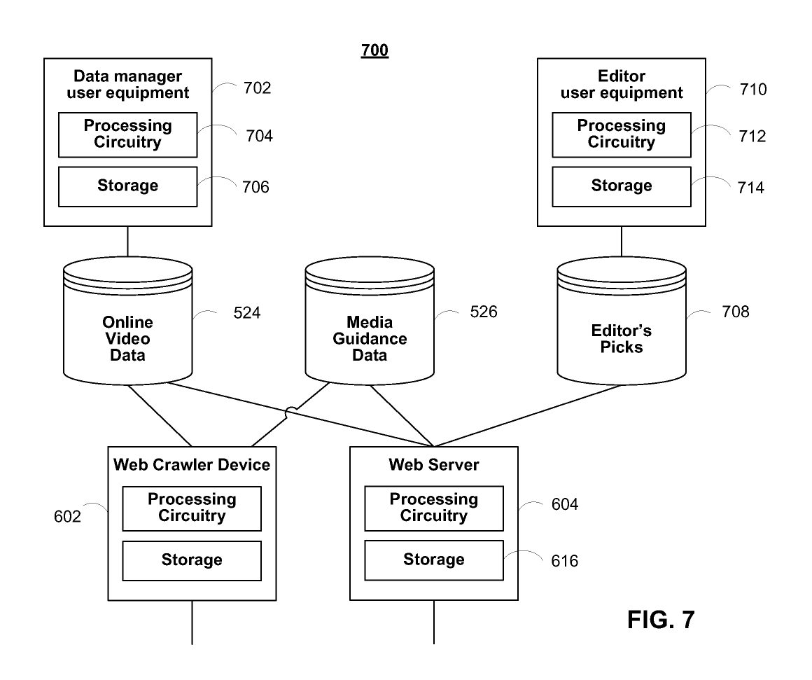

System 700 in FIG. 7 is another illustrative embodiment of media guidance data source 518. FIG. 7 includes the components of FIG. 6, but also includes data manager user equipment 702, editor user equipment 710, and editor's picks data store 708. Data manager user equipment 702 may include processing circuitry 704 and storage 706. Data manager user equipment may be one of user equipment devices 502, 504, or 506. Data manager user equipment 302 may include any or all of the components of user equipment devices. In FIG. 7, data manager user equipment 702 is local to data store 524, and may communicate with data store 524 through any path described in connection with I/O paths 508, 516, and 512. In some embodiments, data manager user equipment is standard user equipment (e.g., laptop, mobile device, etc.) remote from system 700, and a data manager may sign in to gain access through web crawler device 602 or web server 604. Typically, there is more than one data manager user equipment in system 700, but only one is shown to avoid overcomplicating the drawing.

In a typical usage scenario, a data manager may use data manager user equipment to access, retrieve, add, remove, or update entries (including, for example, user profiles 1000, asset profiles 1100) in data store 524. Data managers may correct incorrect information about online videos, remove videos that have become unavailable, add online media information and/or online media content, add tags related to entries in data store 526, or add any information that may be used by web crawler device 602 and web server 604. For example, data managers may tag certain web servers 516 so that any listing from these tagged web servers are accentuated in the listing.

Editor's picks data store 708 may be one or more relational databases or other suitable storage mechanisms. Editor's picks database 708 may contain separate storage space for each editor. Editor's picks database 708 may contain editor preference designations for an individual online media. In addition, editor's picks database 704 may contain hotlists for each editor, where a hotlist is a list of the editor's favorite or preferred media. Editor's picks may also highlight overlooked and obscure media, which may be used as wildcard or unrelated items to diversify browsing results. For each editor preference designation in editor's picks database 708, editor's picks database 708 may store links into data stores 524 and 526. The links may be used by web server 604 when generating displays or gathering data for media guidance applications. In some embodiments, editor's picks data store 708 is part of storage 616 in web server 604.

Editor user equipment 710 may include processing circuitry 712 and storage 714. Editor user equipment 710 may include the features and/or components discussed in connection with data manager user equipment 702. Editor user equipment may communicate, either remotely or locally, with editor's picks data store 708 through any path described in connection with I/O paths 508, 516, and 512. In some embodiments, editor user equipment may have access to a portion of storage 616 in web server 614, and editor preference designations may be stored in storage 616. In a typical usage scenario, an editor may enter preference designations in a manner similar to the way users enter media into a favorites list. Typically, there is more than one editor user equipment in system 700, but only one is shown to avoid overcomplicating the drawing. Editors may be arbitrarily assigned to users, or may be selected or matched community or peers that may highlight media relevant for a community.

As mentioned previously, one of the aims of providing the browsing functionality described herein is to direct users to interesting media that they may not know of. Browsing results may be more diverse than narrowly focused search results. At one extreme, browsing results may be entirely contrary or opposite to search query inputs. At the other extreme, search results may be narrowly focused to exact keywords matches of media asset attributes. Between these two extremes, browse and search results may have user defined diversity so that in a browsing scenario, the user may see diverse results while in a searching scenario, the user may be presented targeted results.

In general, when browsing media, results may be selected based on information input by the viewer at the time of the browse as well as historical user information in order to provide a media selection with some diversity. For example, in an embodiment, current or most recent user information and user interactions may have a relatively high weight or factor in selecting media in browse results, while older information may be given a somewhat lower weight. Because the older information may still used in selecting browsing results, browsing for media will provide different results than a typical keyword search that only uses current user selections.

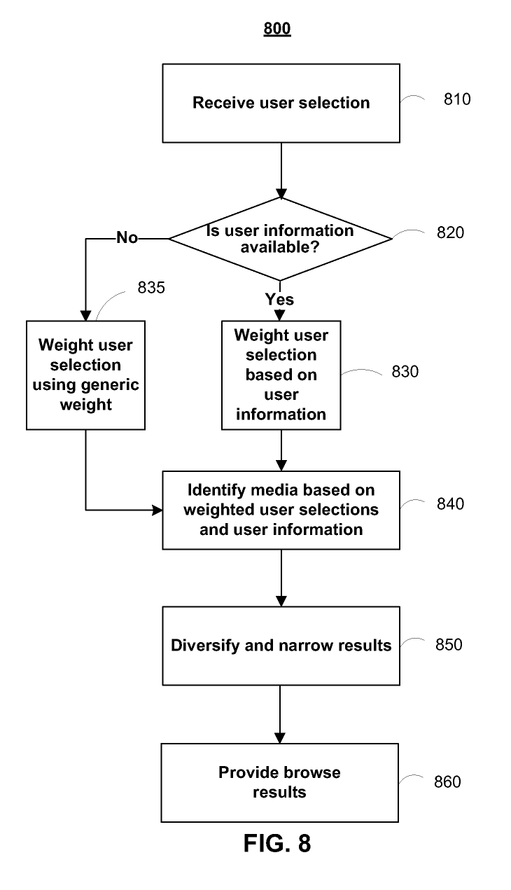

FIG. 8 depicts a high level flow for providing results for a user browsing for media assets. At step 810, a user selection may be received by processing circuitry 406, 1214, 1208 or other processing component used to provide browsing results. The user selection may be any selection made by a user using, for example, a user input interface 410. Some examples of user selections may include selection of a browse button on display 100, entry of a keyword in block 130 of display 100, selection of any media asset icon 140 in display 100, a selection in diversity index 180.

Another way that user selections may be entered is by selection of an icon 140 (for example, using a right mouse click, or some other selection technique) which will cause the processing circuitry 406 to obtain keywords associated with the media asset displayed in icon 140. The keywords associated with a media asset may be obtained by the processing circuitry 406 from a media asset profile 1100. Those keywords, or a subset of the keywords, may be populated in block 130 of display 100, which may be edited by the user to define a browse or search. In another embodiment, the mere selection of an icon 140 may cause a search or browse to be performed using keywords associated with the selected icon's associated media asset, without further interactions by the user.

User information, if available, may be obtained at step 820, by processing circuitry 406 from a user profile 1000 from storage 408, 616 or other source. User profile 1000 as shown in FIG. 10 may be a data file stored in storage 408 or other storage which may include a user identifier 1010, user preferences 1020, user history 1030 and other user information. The user preferences 1020 may be defined by the user or may be determined by the user equipment processing circuitry 406 by analyzing user interactions and viewing history. User history 1030 may include viewer history including, for example, information identifying a viewed media asset, the type of action associated with the asset, and the length of the interaction. Some examples of user history may include a data entry that a viewer viewed information about the U.S. Masters Tournament for 10 seconds, the viewer viewed an entire 21 minute episode of The Office, or a portion of an episode of Dexter. Search history 1030 may also include search histories, including keywords used in a search, subsequent interactions with search results, omitted categories used in presenting results, and other historic data. Search histories may also include data about omitted categories and discarded results, further described herein. Other types of viewer interactions may also be recorded in a user history.

The processing circuitry 406 or some other processing facility, such as a remote facility, may analyze the viewing history, e.g., media viewed or used, duration of the use, and time passed since the media was viewed. The user information, e.g., from user profile 1000, may be used by processing circuitry 406 to weight user selections, if any, at step 830. For example, viewing history (e.g., length of viewing or other interaction) may be used to assign weighting factors to categories of media. In an example, if a user watches an entire current comedy series, a comedy category and a current category may have a relatively high weight. User preference categories obtained by processing circuitry 406 from user profile 1000 may also have a relatively high weight. If the user watches only a few seconds of an old documentary, a documentary category and an older media category may be assigned a relatively low weight by the processing circuitry 406, remote processing, or other suitable facility. In the event that user information is not available, some generic weighting may be applied at step 835 to user selections.

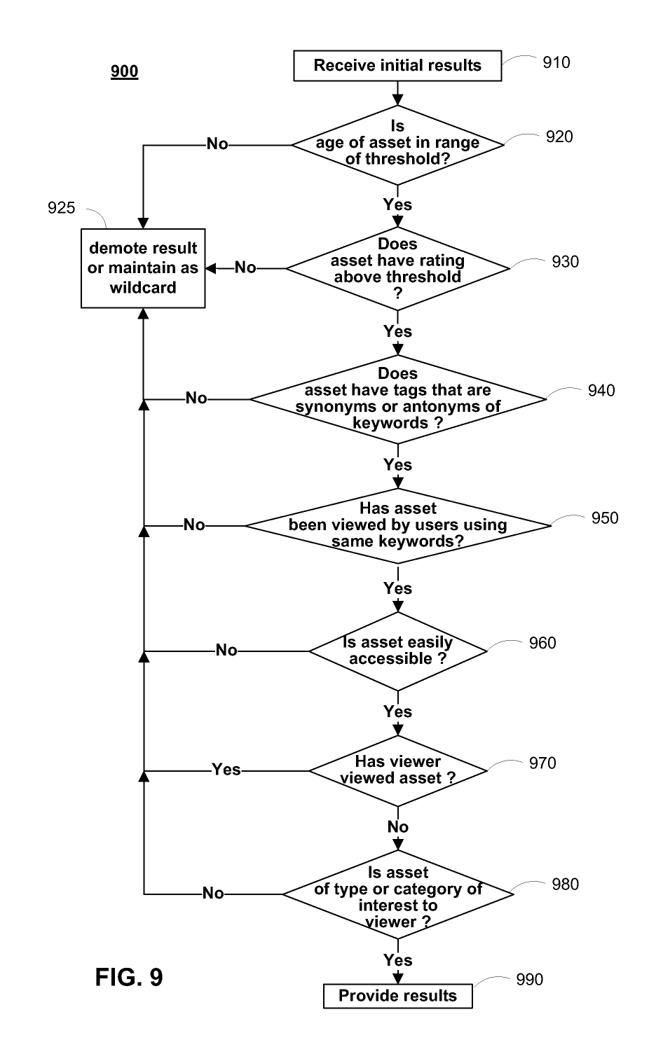

Media may then be identified using processing circuitry 406 in communication with media guidance data source 518 using the weighted user selections and user information at step 840 to provide preliminary results. For the highest weighted categories, processing circuitry 406 may obtain relevant media content results from media guidance data source 518. The media content results may be narrowed and diversified using processing circuitry at step 850 to provide interesting results for the user. Use of step 850 may depend on user selections of the diversity index 180. For example, for a less diverse setting, the diversifying steps may be omitted, or only one slot may be filled with a diverse result. For a search with a high diverse setting, additional slots may be allocated to diverse results, allocated to items in user history, etc. Step 850 is further discussed with reference to FIG. 9. The diversified browsing results may then be presented to the user at step 860, for example, by generating a display screen 100 including the results as media asset icons 140.

The diversification and narrowing step 850 may be performed following the steps in FIG. 9. A first step may be to determine the target number of results to provide in the final results. In addition, a number of slots to be allocated to diverse results may be determined based on user defined diversity settings, e.g., using diversity index 180. The target number of results may be selected by a user as a user preference in the user's profile. The target number of results may be limited to the space available in display 100. The target number may also be limited based on the type of search performed, for example, a standard search may have an unlimited number of results which may be ranked according to a matching algorithm and the results may be viewed by selecting pages of results. In an embodiment of a browse search, the target number of results may be limited, for example, to the available space in a single page of a display 100 so that the viewer can browse through a small number of results without having to wade through pages and pages of results.

Once the target number of results is obtained, in an embodiment, certain slots in the results may be assigned based on user information. For example, if the target number of results is 8, each of the 8 may be allocated based on user information. Using the information in user profile 1000, processing circuitry 406 (or other processing facility) may assign two slots each for sports, comedy, and action based on the user's preferences and viewer history. To fill the other two slots, processing circuitry may use one of the other user preference categories and a wildcard, which may be an unrelated media asset. For example, the other two slots may be filled with a music asset since music is included as a user preference 1020, but the viewing history 1030 does not include any music related interactions, and a wildcard. Music may also be allocated two slots because it was an omitted category in a prior search stored in user history 1030.

To narrow and diversify a final results set, an initial results set may be received by processing circuitry 406 or other processing component at step 910. In order to filter the results based on the allocated slots of the target number so that it can be displayed within display screen 100 which has limited area, and to highlight interesting media, the following steps 920-980 may be performed by processing circuitry to narrow the results. Generally speaking, the steps 920-80 need not be performed in the listed order, and some may be optional. At step 920, a determination may be made, based on metadata associated with media, as to the relative age of the media asset. (Media asset metadata may be obtained by processing circuitry 406 from asset profile shown in FIG. 11, which may be stored in storage 408 or other location.) For users that have a preference for current media, (e.g., as indicated the user profile), certain older media may be demoted, discarded or maintained as a wildcard 925. Age of media may be a range of time and certain thresholds may be assigned to users which are based on user viewing history and age of viewed media, as well as user profile and preferences information. The age of the viewer may also be used as a basis for assigning media age ranges. Ratings of media assets may also be used at step 930 to remove any media assets that are rated poorly. Ratings information may be obtained from media guidance source as well as from community and online sources. Ratings information could also be associated with media assets in its asset profile. A ratings threshold may be user specific, but need not be, and could simply be used as an initial cut to remove any results having poor ratings. In some embodiments, ratings information may only be used if a certain number of ratings have been input. In other embodiments, individual ratings information may be used if it is from trusted sources or friends.

At step 940, processing circuitry 406 may compare media metadata in the respective asset profile to determine whether there are any exact matches for keywords or user information. For example, an asset profile 1100 may include an asset identifier 1110 and asset information 1120 which may include keywords, categories, attributes and other information about the media asset. Processing circuitry 406 may also compare media asset profiles to determine whether any antonyms for keywords or user information or selections exist. In this step, media guidance data source 518 or asset profile 1100 would supply media metadata. A dictionary or other source may be used to identify antonyms for keywords. Media assets that contain synonyms, antonyms or exact matches to keywords or user selections, may be maintained in a result set. Items that do not, may be demoted or saved as wildcards 925 in storage. Another criteria to consider in narrowing results is whether a media asset has been selected for viewing by another viewer using the same keywords or user selections, which is performed at step 950. Such information may be aggregated on a global basis and associated with media assets and metadata in media guidance data source 518.

Another aspect of media results that may be used to differentiate media in a result set is its relative accessibility. At step 960, processing circuitry 406 may review source information for each of the results to determine its accessibility. Source information may be included in an asset profile 1100. Some accessibility measures may include free versus paid access, subscription requirements, number of pages to click through to access the content, source delivery speed, or other access criteria.

Another step for narrowing the results set includes determining at step 970, whether the user has viewed the item. This step may be performed by checking a user's viewing history. Finally, processing circuitry may confirm at step 980, whether the media assets correspond to categories of interest to the user. Such determination may be made by comparing media metadata in an asset profile 1100 and user information in user profile 1000. A narrowed set of results may be obtained at step 990. Any media content demoted, discarded, or designated as a wildcard 925 following the steps of FIG. 9 may be stored for later use.

A final set may be limited to the space available in a display screen (and potentially a certain number of following screens) and may be selected from the results set. As mentioned above, from the narrowed results, media assets may be selected according to allocated slots within the target number of results. Using the prior example, of eight target results filled with two slots for each of sports, comedy, and action, one slot for music and an unrelated media asset, processing circuitry 406 may analyze the results set to select from the final set two media assets to fill slots for spots, comedy and action, and one media asset for music and one unrelated media asset or wildcard. The media assets may be selected using processing circuitry 406 from the final results which were narrowed and ranked according to the steps in FIG. 9 using information about the results from respective asset profiles 1100.

In some embodiments, diversification of the results may be achieved by including one or more wildcard or other unrelated media asset results in the final result set that is displayed to a user in display screen 100. An unrelated asset may be selected by identifying a media asset that has attributes, e.g., 1120 of asset profile 1100, that entirely differ from the attributes of media assets in the result set. In some embodiments, an unrelated media asset may be one that did not survive the results narrowing process in FIG. 9 and which was stored for later use. In some embodiments, an unrelated media asset may be stored for a later browsing event, in other embodiments, unrelated media assets may be revived in a current browse. Such unrelated media assets could be stored in association with the user profile 1000. An unrelated media asset typically is not a good match based on user information and user selections. An unrelated media asset could also be a media asset that is distinctive in other ways, for example, it is highly rated or highly viewed by other viewers, but is not related to a current browse. The unrelated media asset could also be an editor's pick or friend's pick.

In some embodiments the slots for the displayed results may be filled with the highest ranking matching assets. In another embodiment, diversification may be provided by using arbitrary entry within the result set. For example, rather than using the first and second highest ranking items to fill two sports slots, a first item and a tenth item could be used, and to fill two action slots, a second and fifteenth item could be used. Other combinations of randomizing selection of the items may also be used to diversify the results.

In some embodiments, data associated with media assets in the asset profile 1100 may be evaluated by processing circuitry 406 for its distinctiveness in a display screen 100. For example, length of a title of an item, or assets having a title that include search query or user information keywords may be promoted within the results. In addition, a thumbnail image associated with the media asset that may be used for icon 140 may also be evaluated for quality, resolution, and relation to the media asset, keywords and user information.

In other embodiments, combinations and cycling of the above diversification techniques may be used to provide browsing results. For example, in a first browse, an unrelated media asset may be presented in results. In a second set of browse results, a first, second and tenth ranked item may be presented in the results. In a third set of browse results, antonyms may be used to provide matching items. Diversification techniques used in browsing could also be defined and specified in a user profile 1000.

The result set may be presented in a display, e.g., displays 100-300 including selectable icons with images associated with each of the media assets in the result set. The image for each of the media assets in the display may be selected for the display based on the search query or user information. For example, if the user searches or browses for an actor, or the user's preferences include an actor, any media assets included in the results having the actor may use a picture of the actor in the display. In another example, media asset results allocated to a slot for a particular genre or category may use an image associated with the media asset and the category or genre. Marketing images may also be associated with a media asset in its profile and may be used in the displayed results. In some embodiments, a user profile may specify which images to use in search results. In other embodiments, default images may be used. In yet other embodiments, control circuitry may select an image, from a plurality of images, based on relatedness of the image to a search query.

Following presentation of a set of results to a user in a display screen 100, subsequent user selections will be tracked by the guidance application and stored to user profile 1000. For example, data associated with media content selected by the user, and whether the user viewed the entire media asset is stored in the user profile 1000. Keywords or other information associated with the selected media may be stored to the user's profile 1000 for subsequent browsing and searching. Other user selections, such as viewing information about media, may also be stored in user profile 1000.

The search and browse interface described herein may be used together and separately. One advantage of providing these together is that when browsing results lead to media assets that are not interesting to the user, the user may use keywords in a search to find media directly. Conversely, if a user searches for media directly, but then decides to browse for other items, the user may simply select the browse feature and obtain different results than those provided in a search.

The foregoing describes systems and methods for searching and browsing media content using an interactive media guidance application. The above described embodiments of the present invention are presented for purposes of illustration and not of limitation.

1. A method for providing guidance for browsing media on the Internet, comprising:
receiving a user selection;
retrieving user information from storage, the user information indicating at least a user's media interactions;
performing a search of media asset data based on the user selection for media assets;
narrowing results of the search to a subset of media assets by identifying, using the user information, a category of interest to the user, and selecting a result corresponding to the category of interest to the user;
diversifying the subset of media assets by adding an unrelated media asset to the subset of media assets; and
generating a display of the diversified subset of media assets, wherein the display includes at least a graphic associated with each of the subset of media assets, the graphic being selectable to initiate access to the media.

2. The method defined in claim 1 wherein the user selection comprises selecting a media asset icon which causes retrieval of a keyword in a media asset profile for a media asset associated with the selected media asset icon.

3. The method defined in claim 1 further comprising storing data indicating the user selection in the user information.

4. The method defined in claim 1 wherein the user selection comprises selecting a media asset icon which causes retrieval of more than one keyword in a media asset profile for a media asset associated with the selected media asset icon; and selecting one of the more than one keywords.

5. The method defined in claim 1 wherein narrowing results of the search for media assets to a subset of media assets comprises allocating a quantity of results for the identified category of interest based on user media interactions.

6. The method defined in claim 1 wherein narrowing results of the search for media assets to a subset of media assets comprises allocating a quantity of results for the identified category of interest based on user media interactions with media assets in the identified category of interest.

7. The method defined in claim 1 wherein identifying, using the user information, a category of interest to the user comprises: retrieving user history; identifying an interaction with a media asset having a duration exceeding a threshold; obtaining a category associated the media asset; and storing the category in the user information.

8. The method defined in claim 1 wherein diversifying the subset of media assets by adding an unrelated media asset to the subset of media assets comprises selecting a media asset unrelated to the user selection.

9. The method defined in claim 1 wherein diversifying the subset of media assets by adding an unrelated media asset to the subset of media assets comprises selecting a media asset unrelated to the user information.

10. The method defined in claim 1 wherein diversifying the subset of media assets by adding an unrelated media asset to the subset of media assets comprises selecting a media asset having a keyword in its respective media asset profile, the keyword being an antonym of the user selection.

11. The method defined in claim 1 wherein diversifying the subset of media assets by adding an unrelated media asset to the subset of media assets comprises selecting a random media asset.

12. The method defined in claim 1 wherein diversifying the subset of media assets by adding an unrelated media asset to the subset of media assets comprises selecting a media asset contrary to the user selection.

13. The method defined in claim 1 wherein diversifying the subset of media assets is user defined.

14. The method defined in claim 1 wherein the user information comprises monitored user interactions.

15. The method defined in claim 1 further comprising monitoring user interactions in the display of the diversified subset of media assets; and storing data indicating the user interactions.

16. The method defined in claim 15 further comprising providing a second set of media assets based on the monitored user interactions.

17. The method defined in claim 15 wherein the stored data indicating the user interactions is retrievable for a subsequent search for media assets.

18. The method defined in claim 15 further comprising analyzing the user interaction; determining that the duration of the user interaction exceeds a threshold; identifying a media asset associated with the user interaction; retrieving metadata for the identified media asset from an asset profile associated with the identified media asset; storing the media asset metadata in the user profile.

19. The method defined in claim 1 wherein the guidance application data of the display comprises program descriptions, editorial comments, media content related to the videos, or links to Internet sites providing media content related to the indicated videos.

20. The method defined in claim 1 wherein the display is provided by an interactive program guide.

21. The method defined in claim 1 further comprising:
providing search results based on the user selection and the user information;
providing browse results based on the user selection and the user information, wherein the browse results and the search results differ; and
displaying the search results when the user has selected a search, or displaying the browse results when the user has selected a browse.

22. The method defined in claim 1 further comprising providing additional results that are more diverse or less diverse than the diversified subset of media assets based on a user selection in a diversity index.

23. The method defined in claim 1 wherein the graphic associated with each of the subset of media assets is selected from a plurality of graphics associated with each of the subset of media.

24. The method defined in claim 23 wherein the graphic associated with each of the subset of media assets is selected based on an attribute of the respective media asset.

25. The method defined in claim 23 wherein the graphic associated with each of the subset of media assets is selected based on the user selection.

26. A system for providing guidance for browsing media on the Internet, the system comprising control circuitry configured to:
receive a user selection;
retrieve user information from storage, the user information indicating at least a user's media interactions;
perform a search of media asset data based on the user selection for media assets;
narrow results of the search to a subset of media assets by identifying, using the user information, a category of interest to the user, and select a result corresponding to the category of interest to the user;
diversify the subset of media assets by adding an unrelated media asset to the subset of media assets; and
generate a display of the diversified subset of media assets, wherein the display includes at least a graphic associated with each of the subset of media assets, the graphic being selectable to initiate access to the media.

27. The system defined in claim 26 wherein the user selection comprises selecting a media asset icon which causes retrieval of a keyword in a media asset profile for a media asset associated with the selected media asset icon.

28. The system defined in claim 26 wherein the control circuitry is further configured to store data indicating the user selection in the user information.

29. The system defined in claim 26 wherein the user selection comprises selecting a media asset icon which causes retrieval of more than one keyword in a media asset profile for a media asset associated with the selected media asset icon; and selecting one of the more than one keywords.

30. The system defined in claim 26 wherein narrow results of the search for media assets to a subset of media assets comprises allocating a quantity of results for the identified category of interest based on user media interactions.

31. The system defined in claim 26 wherein narrow results of the search for media assets to a subset of media assets comprises allocating a quantity of results for the identified category of interest based on user media interactions with media assets in the identified category of interest.

32. The system defined in claim 26 wherein identify, using the user information, a category of interest to the user comprises: retrieving user history; identifying an interaction with a media asset having a duration exceeding a threshold; obtaining a category associated the media asset; and storing the category in the user information.

33. The system defined in claim 26 wherein diversify the subset of media assets by adding an unrelated media asset to the subset of media assets comprises selecting a media asset unrelated to the user selection.

34. The system defined in claim 26 wherein diversify the subset of media assets by adding an unrelated media asset to the subset of media assets comprises selecting a media asset unrelated to the user information.

35. The system defined in claim 26 wherein diversify the subset of media assets by adding an unrelated media asset to the subset of media assets comprises selecting a media asset having a keyword in its respective media asset profile, the keyword being an antonym of the user selection.

36. The system defined in claim 26 wherein diversify the subset of media assets by adding an unrelated media asset to the subset of media assets comprises selecting a random media asset.

37. The system defined in claim 26 wherein diversify the subset of media assets by adding an unrelated media asset to the subset of media assets comprises selecting a media asset contrary to the user selection.

38. The system defined in claim 26 wherein diversify the subset of media assets is user defined.

39. The system defined in claim 26 wherein the user information comprises monitored user interactions.

40. The system defined in claim 26 wherein the control circuitry is further configured to monitor user interactions in the display of the diversified subset of media assets; and store data indicating the user interactions.

41. The system defined in claim 40 wherein the control circuitry is further configured to provide a second set of media assets based on the monitored user interactions.

42. The system defined in claim 40 wherein the stored data indicating the user interactions is retrievable for a subsequent search for media assets.

43. The system defined in claim 40 wherein the control circuitry is further configured to analyze the user interaction; determine that the duration of the user interaction exceeds a threshold; identify a media asset associated with the user interaction; retrieve metadata for the identified media asset from an asset profile associated with the identified media asset; store the media asset metadata in the user profile.

44. The system defined in claim 26 wherein the guidance application data of the display comprises program descriptions, editorial comments, media content related to the videos, or links to Internet sites providing media content related to the indicated videos.

45. The system defined in claim 26 wherein the display is provided by an interactive program guide.

46. The system defined in claim 26 wherein the control circuitry is further configured to:
provide search results based on the user selection and the user information;
provide browse results based on the user selection and the user information, wherein the browse results and the search results differ; and
display the search results when the user has selected a search, or display the browse results when the user has selected a browse.

47. The system defined in claim 26 wherein the control circuitry is further configured to provide additional results that are more diverse or less diverse than the diversified subset of media assets based on a user selection in a diversity index.

48. The system defined in claim 26 wherein the graphic associated with each of the subset of media assets is selected from a plurality of graphics associated with each of the subset of media.

49. The system defined in claim 48 wherein the graphic associated with each of the subset of media assets is selected based on an attribute of the respective media asset.

50. The system defined in claim 48 wherein the graphic associated with each of the subset of media assets is selected based on the user selection.

51-75. (canceled)
